(19) United States
(12) Patent Application Publication
(10) Pub. No.: US 2020/0094455 A1
(43) Pub. Date: Mar. 26, 2020

(54) OUTER CYLINDER FOR HYDRAULIC SHOCK ABSORBER AND METHOD OF MOLDING THE OUTER CYLINDER FOR THE HYDRAULIC SHOCK ABSORBER

(71) Applicant: KYB Corporation, Minato-ku, Tokyo (JP)

(72) Inventors: Hideto GUMMA, Minato-ku, Tokyo (JP); Asami NAKAI, Gifu-shi, Gifu (JP)

(73) Assignee: KYB Corporation, Minato-ku, Tokyo (JP)

(21) Appl. No.: 16/495,534

(22) PCT Filed: Mar. 22, 2018
(86) PCT No.: PCT/JP2018/011297

§ 371 Date: Sep. 19, 2019

(30) Foreign Application Priority Data
Mar. 23, 2017 (JP) 2017-057168

(51) Int. Cl. B29C 45/14; B29C 45/16

(52) U.S. Cl. CPC B29C 45/14786; B29C 45/14311; B29K 2105/12; B32B 2262/106; B32B 2260/046; B29C 45/1671

(57) ABSTRACT

Providing an outer cylinder for a hydraulic shock absorber, having excellent productivity and a method of molding the outer cylinder for the hydraulic shock absorber. The outer cylinder for the hydraulic shock absorber includes an intermediate body and an outer case body. The intermediate body is formed by weaving (textile-processing) a continuous reinforcement fiber into a cylindrical shape. The outer case body is molded from a polyamide resin that is a thermoplastic resin that forms irregularities on an outside of the intermediate body while being impregnated into the intermediate body. The textile-processing is a process of braiding, weaving or knitting fibers to produce a flat or tubular fabric, cord or the like.

### TECHNICAL FIELD

The present invention relates to an outer cylinder for a hydraulic shock absorber and a method of molding the outer cylinder for the hydraulic shock absorber.

### BACKGROUND ART

Patent Document 1 discloses an electric motor having a rotating shaft formed of carbon fiber reinforced plastic. In the rotating shaft of the motor, a direction in which carbon fibers of a carbon fiber fabric forming the rotating shaft extend is inclined at a predetermined angle to a direction in which the rotating shaft extends. According to this, a torsional breakage torque of the rotating shaft formed of the carbon fiber reinforced plastic can be set to a desired strength. As a result, since the motor can employ the rotating shaft formed of the carbon fiber reinforced plastic instead of a metallic rotating shaft, the weight of the motor can be lighter as compared with the case where a metallic rotating shaft is used.

### PRIOR ART DOCUMENT

### Patent Documents

Patent Document 1:Japanese Patent Application Publication No. JP 2012-257413

### SUMMARY OF THE INVENTION

### Problem to Be Overcome by the Invention

The rotating shaft of this motor is molded by heating and pressing a carbon fiber fabric immersed in molding resin. In other words, the rotating shaft of the motor is molded by use of a thermoset resin. When the carbon fiber fabric is solidified by use of a thermoset resin, the carbon fiber fabric needs to be heated and compressed in a vacuum for a long period of time. Therefore, the productivity of the rotating shaft of the motor is not good. Furthermore, when a thermoset resin is used for the molding of an outer cylinder of a hydraulic shock absorber having complicated irregularities on its outer side, it is difficult to carry out the heating and pressing according to the complicated irregularities. For this reason, it is difficult to use a thermoset resin for molding an outer cylinder of a hydraulic shock absorber.

The present invention was made in view of the above-described circumstances in the conventional art and has an object to provide an outer cylinder for a hydraulic shock absorber, which has an excellent productivity, and a method of molding the outer cylinder for the hydraulic shock absorber

### Means for Overcoming the Problem

An outer cylinder for a hydraulic shock absorber in accordance with the invention includes a cylindrical body and a molded body. The cylindrical body is formed by textile-processing a continuous reinforcement fiber into a cylindrical shape. The molded body is molded from a thermoplastic resin that forms irregularities on an outside of the cylindrical body while being impregnated into the cylindrical body.

The textile-processing is a process of braiding, weaving or knitting fibers to produce a flat or tubular fabric, cord or the like.

The cylindrical body in accordance with the invention may be formed by textile-processing the continuous reinforcement fiber.

A method of molding an outer cylinder for a hydraulic shock, absorber in accordance with the invention includes an intermediate body forming step and an injection molding step. In the intermediate body forming step, a blended yarn made by blending a continuous reinforcement fiber and a thermoplastic resin component is woven along an outer peripheral surface of a mandrel into a cylindrical shape, whereby a cylindrical intermediate body is formed. In the injection molding step, a thermoplastic resin is injected into a mold inside which the intermediate body is disposed, whereby a molded body is formed, the molded body being formed with irregularities on an outside of the intermediate body while being integrated with the intermediate body.

In the injection molding step in accordance with the invention, the thermoplastic resin component of the intermediate body may be heated thereby to be melted by heat of the thermoplastic resin injected into the mold.

The method of molding the outer cylinder for the hydraulic shock absorber in accordance with the invention may further include a solidifying step executed between the intermediate body forming step and the injection molding step. In the solidifying step, the intermediate body is heated so that the thermoplastic resin component is melted, and cooled, whereby a solidified intermediate body is obtained.

The method of molding the outer cylinder for the hydraulic shock absorber in accordance with the invention may further include a covering step executed between the intermediate body forming step and the solidifying step. In the covering step, a covering material having a higher thermal conductivity than the intermediate body is caused to adhere closely to an outer peripheral surface of the intermediate body thereby to cover the intermediate body.

### BRIEF DESCRIPTION OF THE DRAWINGS

FIG. 1 is a cross-sectional view of an outer case of an embodiment, which is an outer cylinder for a hydraulic shock absorber;

FIG. 2 is a schematic diagram of a shock absorber employing the outer case of the embodiment, which is the outer cylinder for the hydraulic shock absorber;

FIG. 3 is a schematic view illustrating a method of forming an intermediate body in the embodiment; and

FIG. 4 is a cross-sectional view illustrating: a mold used for molding the outer case of the embodiment, which is the outer cylinder for the hydraulic shock absorber; the solidified intermediate body disposed in a molding space in the mold; a first metal fitting; and a second metal fitting.

### BEST MODE FOR CARRYING OUT THE INVENTION

### EMBODIMENT

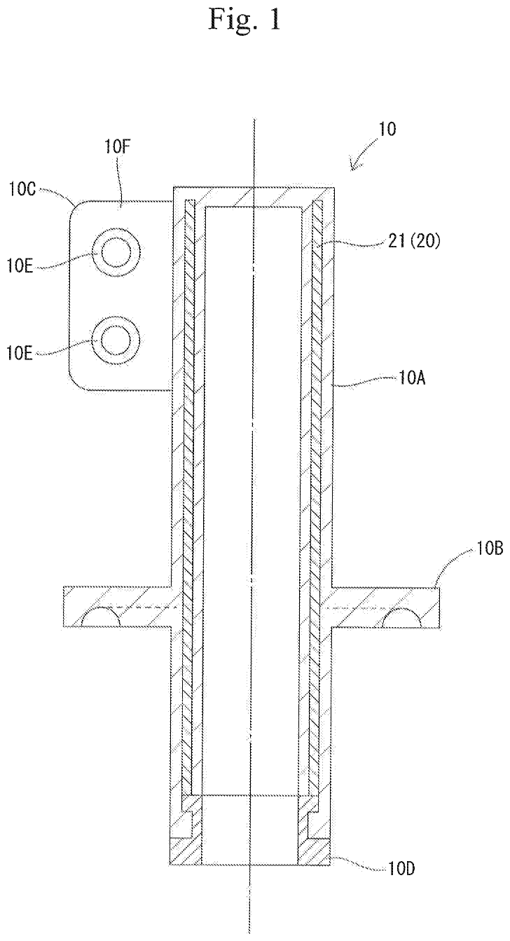

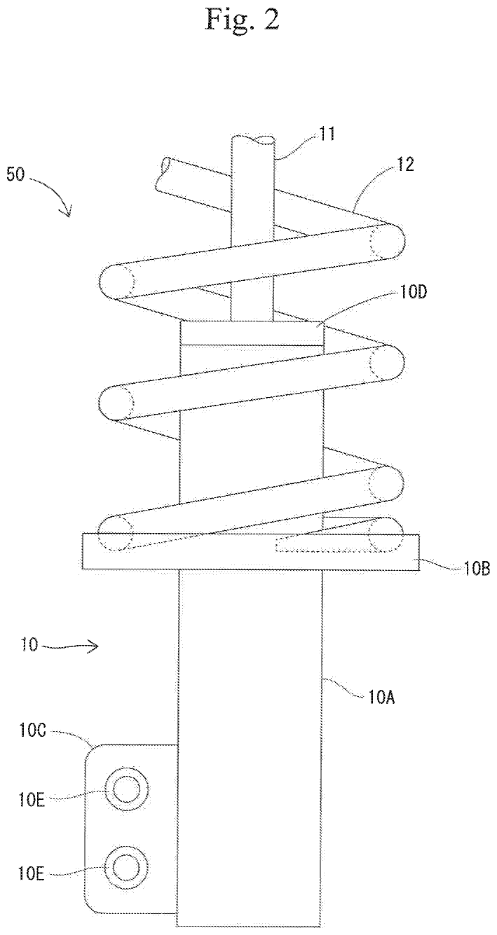

An outer case 10 serving as an outer cylinder for a hydraulic shock absorber includes an outer case body 10A, a spring receiving part 10B, and a knuckle bracket 10C, as illustrated in FIG. 1. The cuter case 10 is usable as the outer case 10 of a strut-type suspension which is a suspension 50 interposed between a vehicle (not illustrated) and a wheel (not illustrated) of the vehicle (see FIG. 2).

The outer case body 10A serving as a molded body is cylindrical in shape and extends in one direction. The outer case body 10A is formed by injection-molding a thermoplastic resin such as polyamide. The outer case body 10A has two ends one of which is open and the other of which is closed. A first metal fitting 10D made of a metal is provided in the open end of the outer case body 10A. The first metal fitting 10D is connected with the outer case body 10A by insert melding, outsert molding, or another joining or fastening method. The first metal fitting 10D is cylindrical in shape and has two ends (one end and the other end) both of which are open and communicate with each other. The other end of the first metal fitting 10D has a smaller outer diameter than the one end of the first metal fitting 10D. The first metal fitting 10D is provided in communication with the one end of the outer case body 10A with an outer periphery of the other end the first metal fitting 10D being in abutment against an inner periphery of the one end of the outer case body 10A.

The outer case body 10A is provided with an intermediate body 20 serving as a cylindrical body. The intermediate body 20 is formed by weaving (textile-processing) blended yarns 20A containing a carbon fiber serving as continuous reinforcement fiber and a thermoplastic resin component, into a cylindrical shape having two ends both of which are open and communicate with each other. In other words, the intermediate body 20 serving as a cylindrical body is formed by weaving a carbon fiber into the cylindrical shape The thermoplastic resin component is obtained by making the thermoplastic resin such as polyamide into a fibrous form. The thermoplastic resin component is of the same material as that of the thermoplastic resin forming the outer case body 10A. The intermediate body 20 has an inner diameter that is slightly larger than that of the cylindrical outer case body 10A. Furthermore, the intermediate body 20 has an outer diameter that is slightly smaller than that of the cylindrical outer case body 10A. The intermediate body 20 further has a longitudinal dimension that is slightly smaller than that of the cylindrical outer case body 10A. The intermediate body 20 is provided inside the outer case body 10A by insert molding. A periphery of the intermediate body 20 is covered with the thermoplastic resin forming the outer case body 10A. As 3 result, mechanical properties of the outer case body 10A, such as stiffness, can be rendered favorable as compared with the case where no intermediate body 20 is provided.

The spring receiving part 10B is provided so as to protrude outward from an outer peripheral surface of a longitudinally middle part of the outer case body 10A in a flange-like manner. The spring receiving part 10B is formed by injection molding with use of a thermoplastic resin such as polyamide, and formed integrally with the outer case body 10A.

A pair of the knuckle brackets 10C is provided on the other end of the outer case body 10A. The knuckle brackets 10C are formed by injection molding with use of a thermoplastic resin such as polyamide, and formed integrally with the outer case body 10A. The knuckle brackets 10C have respective planar parts 10F formed to be planar and opposed to each other. A direction in which the planar parts 10F of the knuckle brackets 10C extend is parallel to the longitudinal direction of the outer case body 10A. The cuter case body 10A is thus formed of the thermoplastic resin further forming the spring receiving part 10B and the knuckle brackets 10C on the outside of the intermediate body 20. The spring receiving part 103 and the knuckle brackets 10C are examples of irregularities.

Two second metal fittings 10E are provided in each knuckle bracket ICC. The second metal fittings 10E are provided in the knuckle bracket 10C by insert molding. Each second metal fitting 10E is cylindrical in shape and has two ends both of which are open and communicate with each other. Each second metal fitting 10E is provided in the knuckle bracket 10C such that the direction in which the central axis of the cylindrical shape extends is perpendicular to the planar part 10F of the knuckle bracket 10C. In the pair of knuckle brackets 10C, the central axis of the cylindrical shape of the second metal fitting ICE provided in one knuckle bracket 10C and the central axis of the cylindrical shape of the second metal fitting 10E provided in the other knuckle bracket 10C are arranged in a straight line with each other. An interior of the cylindrical shape of each second metal fitting 10E is not filled with a thermoplastic resin, and the one end and the other end of each second metal fitting 10E are open and communicate with each other. The outer case body 10A is thus formed.

FIG. 2 illustrates an example of a shock absorber 50 employing the outer case 10. The shock absorber 50 has the cuter case 10, a piston rod 11, and a suspension spring 12. The piston rod 11 is columnar in shape and is inserted into the cuter case body 10A from the open end of the outer case body 10A so as to be extensible and contractible relative to the outer case body 10A. An upper mount (not illustrated) is provided on a distal end of the piston rod 11 projecting out of the open end of the outer case body 10A. The upper mount is provided with a spring receiving surface (not illustrated) opposed to the flange-like spring receiving part 10B of the outer case 10.

The suspension spring 12 is a compression coil spring. The suspension spring 12 is inserted onto the piston rod 11 and the outer case body 10A. The suspension spring 12 is held between the spring receiving part 10B of the outer case 10 and the spring receiving surface of the upper mount. The shock absorber 50 employing the outer case 10 is thus constructed.

The upper mount is coupled to the vehicle side, and a knuckle (not illustrated) provided m a wheel of the vehicle is disposed between the opposed planar parts 10F of the pair of knuckle brackets 10C and coupled thereto. Thus, the shock absorber 50 can be installed between the vehicle and the wheel of the vehicle.

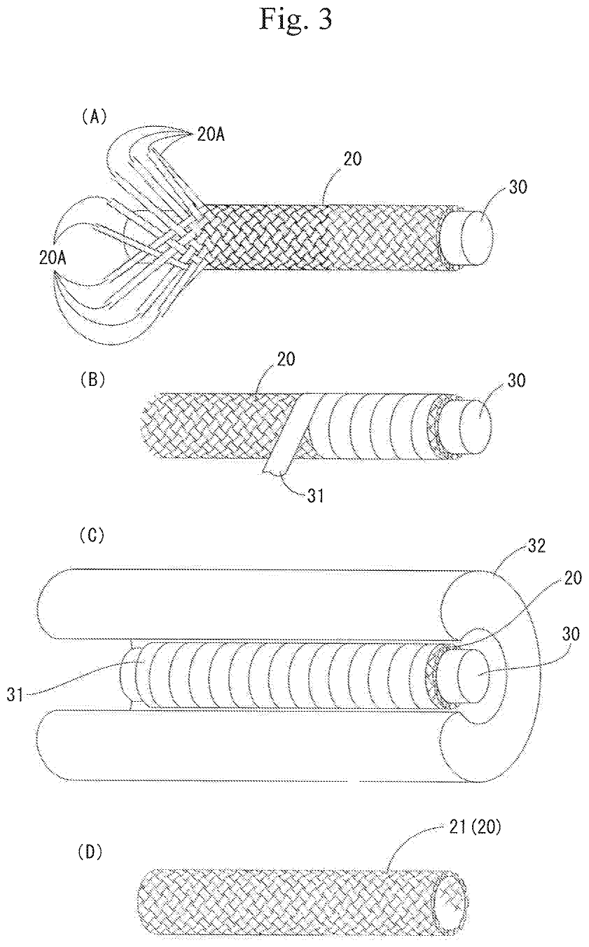

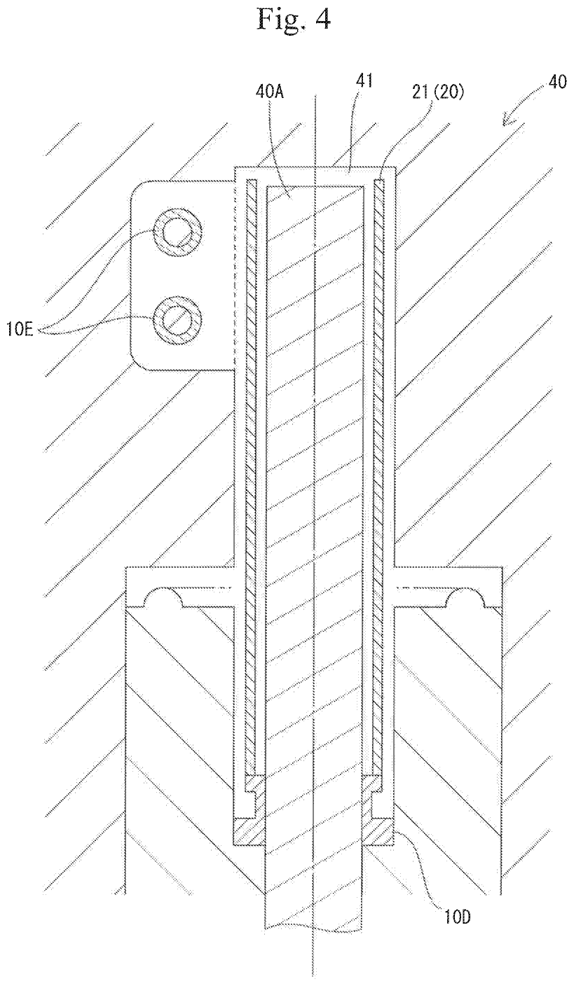

Next, a method of forming the outer case 10 will be described with reference to FIG. 3 (A) to (D) and FIG. 4.

Firstly, as illustrated in FIG. 3(A), a blended yarn 20A made by blending a continuous reinforcement fiber and a thermoplastic resin component is woven along an outer peripheral surface of a mandrel 30 into a cylindrical shape, whereby the cylindrical intermediate body 20 is formed (an intermediate body forming step).

Firstly, the blended yarn 20A is set in a braiding machine (not illustrated). Here, the braiding machine is a known machine and has a mandrel 30 which is elongated in one direction and is circular in an outer shape, and a plurality of reels (not illustrated) for spooling and holding the blended yarn 20A which serves as a braiding yarn. These reels (not. illustrated) are arranged side by side in a circumferential direction of the outer peripheral surface of the mandrel 30 at a predetermined distance from the outer peripheral surface of the mandrel 30 so as to surround the outer peripheral surface of the mandrel 30. With use of the blended yarns 20A wound on the respective reels, the braiding machine can weave the blended yarns 20A along the outer peripheral surface of the mandrel 30 thereby to manufacture the intermediate body 20 which is a cylindrical braid (see FIG. 3(A)). In other words, the intermediate body 20 serving as a cylindrical body is formed by weaving carbon fibers into a cylindrical braid shape.

Next, between the intermediate body forming step and a solidifying step which will be described later, a covering material 31 having a higher thermal conductivity than the intermediate body 20 is caused to adhere closely to the outer peripheral surface of the intermediate body 20 thereby to cover the intermediate body 20 (a covering step). In more detail, as illustrated in FIG. 3(B), the covering material 31 is wrapped around the outer peripheral surface of the intermediate body 20 woven along the outer peripheral surface of the mandrel 30. The covering material 31 has a predetermined width and is strip-shaped, elongated in one direction. The covering material 31 is made of a metal such as stainless steel. At this time, the covering material 31 is wrapped around the outer peripheral surface of the intermediate body 20 in a spiral manner. The covering material 31 is covered on the outer peripheral surface of the intermediate body 20 in such a manner that no gaps are generated between the adjacent spiral turns of the covering material 31. The covering step is thus completed. Instead of the strip-shaped covering material 31, the outer peripheral surface of the intermediate body 20 woven along the outer peripheral surface of the mandrel may be covered with a pair of covering materials each formed by axially halving a cylinder, and then the intermediate body 20 may be pressed.

Next, the intermediate body 20 covered with the covering material 31 is heated so that the thermoplastic resin component is melted and then cooled, whereby a solidified intermediate body 21 is obtained (a solidifying step). As illustrated in FIG. 3(C), the intermediate body 20, which has been woven on the outer peripheral surface of the mandrel 30 into the cylindrical shape and has the covering material 31 wrapped around the outer peripheral surface thereof, is put into a heater 32. In more detail, the heater 32 is formed to be elongated in one direction and has an arc-shaped cross-sectional shape in a direction orthogonal to the longitudinal direction. The arc-shaped heater 32 has an inner diameter that is larger than an outer diameter of the covering material 31 wrapped around the outer peripheral surface of the intermediate body 20. The intermediate body 20, which has been woven on the outer peripheral surface of the mandrel 30 into the cylindrical shape and has the covering material 31 wrapped around the outer peripheral surface thereof, is put into a heater 32 along the longitudinal direction of the heater 32. Thereupon, the thermoplastic resin component of the intermediate body 20 put into the heater 32 is melted, and the melted thermoplastic resin component is impregnated into the carbon fibers of the intermediate body 20 without protruding outside from the covering material 31. After a lapse of a predetermined period of time, the intermediate body 20, which has been woven on the outer peripheral surface of the mandrel 30 into the cylindrical shape and has the covering material 31 wrapped around the outer peripheral surface thereof, is taken out of the heater 32 and cooled. As a result, the thermoplastic resin component melted and impregnated into the carbon fibers of the intermediate body 20 is resolidified. The solidifying step is thus completed.

Then, the covering material 31 wrapped around the outer peripheral surface of the intermediate body 20 is unwrapped to be detached from the outer peripheral surface of the intermediate body 20, and the mandrel 30 is pulled out of the intermediate body 20. Thus, a solidified intermediate body 21 which is the intermediate body 20 solidified while maintaining the cylindrical shape can be obtained. The covering material 31 detached from the solidified intermediate body 21 and the mandrel 30 are repeatedly reusable.

Then, the solidified intermediate body 21 thus obtained, the first metal fitting 10D and the second metal fittings IDE are disposed in a molding space 41 inside a mold 40. In more detail, as illustrated in FIG. 4, the mold 40 is opened, and the first metal fitting 10D and the solidified intermediate body 21 are disposed with a columnar core pin 40A provided in the molding space 41 inside the mold 40 being inserted therethrough. At this time, one end of the solidified intermediate body 21 and the other end of the first metal fitting 10D is in abutment against each other. An inner diameter of the first metal fitting 10D is substantially the same as an outer diameter of the core pin 40A. In ocher words, the inner peripheral surface of the first metal fitting 100 is in abutment against an outer peripheral surface of the core pin 40A. The solidified intermediate body 21 has an inner diameter that is slightly larger than the outer diameter of the core pin 40A. As a result, the solidified intermediate body 21 can be disposed such that an inner peripheral surface of the solidified intermediate body 21 is not brought into contact with the outer peripheral surface of the core pin 40A. The second metal fittings 10E are then disposed in the molding space 41 inside the mold 40, and the mold 40 is closed. At this time, the solidified intermediate body 21 is disposed in the molding space inside the mold 40 such that the outer peripheral surface of the solidified intermediate body 21 is net brought into contact with a wall surface defining the molding space 41 inside the mold 40.

Next, thermoplastic resin is injected into the molding space 41 inside the mold 40 in which the solidified intermediate body 21, the first metal fitting 10D and the second metal fittings 10E are disposed, whereby the outer case body 10A, which is formed with irregularities on the outside of the solidified intermediate body 21 while being integrated with the solidified intermediate body 21, is formed (an injection molding step). In more detail, the thermoplastic resin is injected into the molding space 41 inside the mold 40 in which the solidified intermediate body 21, the first metal fitting 100 and the second metal fittings 10E are disposed. The thermoplastic resin injected into the molding space 41 inside the mold 40 covers a whole of the outer peripheral surface and the inner peripheral surface of the solidified intermediate body 21.

At this time, the thermoplastic resin component of the solidified intermediate body 21 is melted again by the heat of the thermoplastic resin injected into the molding space 41 inside the mold 40. In other words, the thermoplastic resin component of the solidified intermediate body 21 is heated by the heat of the thermoplastic resin injected into the molding space 41 of the mold 40 thereby to be melted. Thereupon, the thermoplastic resin components near the outer and inner peripheral surfaces of the solidified intermediate body 21 are fused with the thermoplastic resin component injected into the molding space 43. inside the mold 40. Furthermore, when the solidified intermediate body 21 has a region where the thermoplastic resin component is not unimpregnated, the thermoplastic resin injected into the molding space 41 inside the mold 40 is impregnated into the region of the solidified intermediate body 21 where the thermoplastic resin component is not unimpregnated. After the injected thermoplastic resin is filled in every corner of the molding space 41 inside the mold 40, pressure keeping and cooling are executed, then the mold 40 is opened, and the outer case 10 is taken out of the molding space 41 inside the mold 40. The injection molding step is thus completed. Since the thermoplastic resin components near the outer and inner peripheral surfaces of the solidified intermediate body 21 are fused with the thermoplastic resin component injected into the molding space 41 inside the mold 40, the solidified intermediate body 21 and the thermoplastic resin injected into the molding space 41 inside the mold 40 are unlikely to separate from each other.

Thus, the outer cylinder for the hydraulic shock absorber is molded while the thermoplastic resin heated to be melted is impregnated into the continuous reinforcement fibers. The thermoplastic resin heated to be melted can be solidified in a short time by being cooled. Furthermore, since the thermoplastic resin need not be heated and compressed, but can be injected into the molding space 41 inside the mold 40 to be molded, a desired shape can be easily obtained. As a result, the outer cylinder for the hydraulic shock absorber can easily be provided with complex irregularities by use of the thermoplastic resin.

Accordingly, the outer cylinder for the hydraulic shock absorber in accordance with the present invention has an excellent productivity.

Furthermore, the cylindrical body is formed by weaving the continuous reinforcement fibers into the braid shape. A braided product is made by crossing braiding yarns (fiber bundles) with one another. A crossing angle of the braiding yarns is optionally changeable. In other words, mechanical properties of the cylindrical body itself can be changed by changing the structure of the braided product in various ways.

Furthermore, the method of molding the outer cylinder for the hydraulic shock absorber includes the intermediate body forming step and the injection molding step. In the intermediate body forming step, the blended yarn 20A made by blending the continuous reinforcement fiber and the thermoplastic resin component is woven along the outer peripheral surface of a mandrel 30 into a cylindrical shape, whereby the cylindrical intermediate body 20 is formed. In the injection molding step, thermoplastic resin is injected into the molding space 41 of the mold 40 in which the intermediate body 20 is disposed, whereby the outer case body 10A is formed, the outer case body 10A being formed with the irregularities on the outside of the solidified intermediate body 21 while being integrated with the solidified intermediate body 21. Thus, in the method of molding the outer cylinder for the hydraulic shock absorber, the intermediate body 20 which has been formed to have a desired outer diameter can be disposed in the molding space 41 inside the mold 40. As a result, the position where the intermediate body 20 is disposed in the molding space 41 inside the mold 40 can be easily adjusted. Furthermore, the outer cylinder for the hydraulic shock absorber can be molded while the thermoplastic resin heated to be melted is impregnated into the continuous reinforcement fibers. The thermoplastic resin heated to be melted can be solidified in a short time by being cooled.

Accordingly, the outer cylinder for the hydraulic shock absorber having desired mechanical characteristics can be easily molded by the method of molding the outer cylinder for the hydraulic shock absorber, so that the method has an excellent productivity.

Furthermore, in the injection molding step, the thermoplastic resin component of the intermediate body 20 is heated and melted by the heat of the thermoplastic resin injected into the molding space 41 of the mold 40. Thus, in the method of molding the cuter cylinder for the hydraulic shock absorber, when the thermoplastic resin component is melted, the thermoplastic resin component can be fused with the thermoplastic resin injected into the molding space 41 inside the mold 40, while being impregnated into the continuous reinforcement fibers of the intermediate body 20. As a result, the outer cylinder for the hydraulic shock absorber having more favorable mechanical properties can be molded by the method of molding the outer cylinder for the hydraulic shock absorber.

Furthermore, the method of molding the outer cylinder for the hydraulic shock absorber includes the solidifying step executed between the intermediate body forming step and the injection molding step. In the solidifying step, the intermediate body 20 is heated so that the thermoplastic resin component is melted, and then cooled, whereby the solidified intermediate body 21 is obtained. Thus, in this method of molding the outer cylinder for the hydraulic shock absorber, since the thermoplastic resin component of the intermediate body can be melted in advance, the melted thermoplastic resin component can be favorably impregnated into the continuous reinforcement fibers. As a result, the outer cylinder for the hydraulic shock absorber having more favorable mechanical properties can be molded by the method of molding the outer cylinder for the hydraulic shock absorber.

Furthermore, the method of molding the outer cylinder for the hydraulic shock absorber includes the covering step executed between the intermediate body forming step and the solidifying step. In the covering step, the covering material 31 having a higher thermal conductivity than the intermediate body 20 is caused to adhere closely to the outer peripheral surface of the intermediate body 20 thereby to cover the intermediate body 20. Thus, in the covering step, the covering material 31 is caused to adhere closely to the outer peripheral surface of the intermediate body 20 while tension is applied to the covering material 31, whereby the continuous reinforcement fiber bundles can be caused to closely adhere to one another so that the formation of voids resulting in internal defect can be reduced, with the result that the mechanical properties of the outer cylinder for the hydraulic shock absorber can be further improved. Furthermore, covering the intermediate body 20 with the covering material 31 can prevent the loss of the thermoplastic resin component eluted from the intermediate body 20 during heating. Still furthermore, since the covering material 31 has a higher thermal conductivity than the intermediate body 20, heat can be uniformly applied over the entire intermediate body 20 in the solidifying step, and therefore the thermoplastic resin component of the intermediate body 20 can be melted evenly, and the melted thermoplastic resin component can be more favorably impregnated into among the continuous reinforcement fiber bundles. As a result, the outer cylinder for the hydraulic shock absorber having more favorable mechanical properties can be molded.

### OTHER EMBODIMENTS

Other embodiments which are modifications of the above-described embodiment will hereinafter be described briefly.

(1) Although the cuter case of the shock absorber is disclosed as the cylindrical body in the foregoing embodiment, the cylindrical body may be any type of cylindrical member.
(2) Although the blended yarn made by blending the continuous reinforcement fiber and the thermoplastic resin component is woven into the cylindrical braid shape in the foregoing embodiment, the cylindrical body may be formed by entwining the blended yarn into an unwoven cloth shape, instead. Furthermore, the cylindrical body may be formed by braiding, weaving or knitting the blended yarn.
(3) Although the polyamide resin is used as the thermoplastic resin and the thermoplastic resin component in the foregoing embodiment, another thermoplastic resin may be used as the thermoplastic resin and the thermoplastic resin component, instead, or these thermoplastic resins may be used in a mixed manner.
(4) Although stainless steel is used as the covering material in the foregoing embodiment, another metal may be used as the covering material, instead.
(5) Although the carbon fiber is used as the continuous reinforcement fiber in the foregoing embodiment, another fiber such as glass fiber or aramid fiber may be used as the continuous reinforcement fiber, instead, or these fibers may be used in a mixed manner.
(6) Although the first metal fitting is provided in the foregoing embodiment, no first metal fitting may be provided, and a space in which the first metal fitting is to be provided may be filled with the thermoplastic resin, the continuous reinforcement fiber or the like.
(7) Although the spring receiving part provided in the circumferential direction of the cylindrical body and the knuckle bracket are exemplified as irregularities in the foregoing embodiment, the irregularities may be formed not only in the circumferential direction but also in the axial direction of the cylindrical body. As the irregularities provided in the axial direction of the cylindrical body, a mounting eye may be formed.

### EXPLANATION OF REFERENCE SYMBOLS

10A . . . outer case body (molded body),

20 . . . intermediate body (cylindrical body),

30 . . . mandrel,

31 . . . covering material, and

21 . . . solidified intermediate body (intermediate body).

1. An outer cylinder for a hydraulic shock absorber, comprising:
a cylindrical body formed by textile-processing a continuous reinforcement fiber into a cylindrical shape; and
a molded body molded from a thermoplastic resin that forms irregularities on an outside of the cylindrical body while being impregnated into the cylindrical body.

2. The outer cylinder for the hydraulic shock absorber, according to claim 1, wherein the cylindrical body is formed by textile-processing the continuous reinforcement fiber into a braid shape.

3. A method of molding an outer cylinder for a hydraulic shock absorber, comprising:
an intermediate body forming step of weaving a blended yarn along an outer peripheral surface of a mandrel into a cylindrical shape, thereby forming a cylindrical intermediate body, the blended yarn being made by blending a continuous reinforcement fiber and a thermoplastic resin component; and
an injection molding step of injecting a thermoplastic resin into a mold inside which the intermediate body is disposed, thereby forming a molded body, the molded body being formed with irregularities on an outside of the intermediate body while being integrated with the intermediate body.

4. The method of molding the outer cylinder for the hydraulic shock absorber, according to claim 3, wherein in the injection molding step, the thermoplastic resin component of the intermediate body is heated thereby to be melted by heat of the thermoplastic resin injected inside the mold.

5. The method of molding the outer cylinder for the hydraulic shock absorber, according to claim 4, further comprising a solidifying step of heating the intermediate body so that the thermoplastic resin component is melted, and cooling the melted thermoplastic resin component, thereby obtaining a solidified intermediate body, the solidifying step being executed between the intermediate body forming step and the injection molding step.

6. The method of molding the outer cylinder for the hydraulic shock absorber, according to claim 5, further comprising a covering step of causing a covering material having a higher thermal conductivity than the intermediate body to adhere closely to an outer peripheral surface of the intermediate body, thereby covering the intermediate body, the covering step being executed between the intermediate body forming step and the solidifying step.

7. The method of molding the outer cylinder for the hydraulic shock absorber, according to claim 3, further comprising a solidifying step of heating the intermediate body so that the thermoplastic resin component is melted, and cooling the melted thermoplastic resin component, thereby obtaining a solidified intermediate body, the solidifying step being executed between the intermediate body forming step and the injection molding step.

8. The method of molding the outer cylinder for the hydraulic shock absorber, according to claim 7, further comprising a covering step of causing a covering material having a higher thermal conductivity than the intermediate body to adhere closely to an outer peripheral surface of the intermediate body, thereby covering the intermediate body, the covering step being executed between the intermediate body forming step and the solidifying step.
